(19) United States
(12) Patent Application Publication
(10) Pub. No.: US 2024/0353948 A1
(43) Pub. Date: Oct. 24, 2024

(54) GRIP GESTURE RECOGNITION METHOD AND APPARATUS, DEVICE, STORAGE MEDIUM, AND CHIP

(71) Applicant: BEIJING XIAOMI MOBILE SOFTWARE CO., LTD., Beijing (CN)

(72) Inventors: Rumeng WANG, Beijing (CN); Wenjun GAO, Beijing (CN)

(21) Appl. No.: 18/721,614

(22) PCT Filed: Jul. 27, 2022
(86) PCT No.: PCT/CN2022/108405

§ 371 Date: Jun. 18, 2024

(51) Int. Cl. G06F 3/041; G06F 3/14

(52) U.S. Cl. CPC G06F 3/0416; G06F 3/1423; G06F 2203/04102; G06F 2203/04104

(57) ABSTRACT

A method for recognizing gripping posture includes: obtaining first sensor data of a touch sensor arranged on a side bezel of a first screen of a terminal fold able screen, obtaining a touch parameter of a second screen of the terminal fold able screen, and determining a gripping posture of the terminal according to the first sensor data and the touch parameter, where the gripping posture includes single-sided gripping on first side, single-sided gripping on second side or double-sided gripping.

### CROSS-REFERENCE

The present application is a U.S. National Stage of International Application No. PCT/CN2022/108405, filed on Jul. 27, 2022, the contents of all of which are incorporated herein by reference in their entireties for all purposes.

### BACKGROUND

As intelligent terminals have been booming, foldable-screen terminals also have emerged. The foldable-screen terminals have functions of ordinary single-screen terminals, and further foldable screens can be unfolded to expand terminal screens. However, the foldable-screen terminals have problems accordingly. Compared with the single-screen terminals, the foldable-screen terminals are controlled in a limited range with one hand when in use due to screen expansion.

### SUMMARY

According to a first aspect of an example of the disclosure, a method for recognizing gripping posture is provided. The method is performed by a terminal. The terminal includes a foldable screen. The foldable screen includes a first screen and a second screen. The method includes:
obtaining first sensor data of a touch sensor arranged on a side bezel of the first screen;
obtaining a touch parameter of the second screen; and
determining a gripping posture of the terminal according to the first sensor data and the touch parameter, where the gripping posture includes single-sided gripping on first side, single-sided gripping on second side or double-sided gripping.

According to a second aspect of an example of the disclosure, an electric device is provided. The electric device is applied to a terminal. The terminal includes a foldable screen. The foldable screen includes a first screen and a second screen. The electric device includes: a processor; and a memory configured to store a processor-executable instruction.

The processor is configured to:
obtain first sensor data of a touch sensor arranged on a side bezel of the first screen;
obtain a touch parameter of the second screen; and
determine a gripping posture of the terminal according to the first sensor data and the touch parameter, wherein the gripping posture comprises single-sided gripping on first side, single-sided gripping on second side or double-sided gripping.

According to a third aspect of an example of the disclosure, a non-transitory computer-readable storage medium is provided. The non-transitory computer-readable storage medium stores a computer program instruction. The non-transitory computer-readable storage medium is applied to a terminal. The terminal includes a foldable screen. The foldable screen includes a first screen and a second screen. The program instruction, when executed by a processor, implements following steps of:
obtaining first sensor data of a touch sensor arranged on a side bezel of the first screen;
obtaining a touch parameter of the second screen; and
determining a gripping posture of the terminal according to the first sensor data and the touch parameter, wherein the gripping posture comprises single-sided gripping on first side, single-sided gripping on second side or double-sided gripping.

### BRIEF DESCRIPTION OF DRAWINGS

FIG. 1 is a flow diagram of a method for recognizing gripping posture according to an example.

FIG. 2 is a schematic structural diagram of a foldable-screen terminal in an unfolded state according to an example.

FIG. 3 is a flow diagram of another method for recognizing gripping posture according to an example.

FIG. 4 is a flow diagram of yet another method for recognizing gripping posture according to an example.

FIG. 5 is a schematic diagram of a display interface of a terminal according to an example.

FIG. 6 is a block diagram of an apparatus for recognizing gripping posture according to an example.

FIG. 7 is a block diagram of another apparatus for recognizing gripping posture according to an example.

### DETAILED DESCRIPTION

Examples will be described in detail here and shown in accompanying drawings illustratively. When the following descriptions relate to accompanying drawings, unless otherwise specified, the same numeral in different accompanying drawings denotes the same or similar elements. The embodiments described in the following examples do not denote all embodiments consistent with the disclosure. On the contrary, the embodiments are merely instances of apparatuses and methods consistent with some aspects of the disclosure as detailed in the appended claims.

It can be understood that the term “plurality” in the disclosure refers to two or above, and other quantifiers are understood in a similar way. The term “and/or” describing an association relation between associated objects indicates that there can be three relations. For instance, A and/or B can represent A alone, both A and B, and B alone. The character “/” generally indicates that associated objects in the context are in an “or” relation. The singular forms such as “a”, “an”, “the”, “this” and “these” used are also intended to include the plural forms, unless otherwise clearly stated in the context.

It can be further understood that the terms “first”, “second”, etc. are used for describing various information, but this information should not be limited by these terms. These terms are merely used to distinguish the same type of information from each other, and do not denote any specific order or importance. In fact, the expressions “first”, “second”, etc. can be used interchangeably. For instance, a first screen can also be referred to as a second screen, and similarly, a second screen can also be referred to as a first screen, without departing from the scope of the disclosure.

It can be further understood that although operations are described in the accompanying drawings in specific order in examples of the disclosure, it should not be understood that these operations are required to be executed in shown specific order or in serial order, or that all illustrated operations are required to be executed so as to realize expected results. In specific environments, multitasking and parallel processing may be advantageous.

It should be noted that all actions to acquire signals, information or data in the disclosure are carried out under the premise of complying with corresponding data protection laws and policies of a country where an apparatus is located and obtaining authorization from the owner of the corresponding apparatus.

A foldable-screen terminal generally include a main screen and a secondary screen. In a folded state, the secondary screen can be folded on a back of the terminal. In an unfolded state, the main screen and the secondary screen can constitute a screen having a larger size such that a foldable screen can be unfolded to expand a terminal screen while functions of an ordinary single-screen terminal are satisfied.

Moreover, the applicant finds that the foldable-screen terminal also has corresponding problems. Compared with a single-screen terminal, due to screen expansion of the foldable-screen terminal, a single-handed control range cannot cover the entire screen when the foldable-screen terminal is used in an unfolded state. Thus, it is required to recognize a hand when a user holds a terminal. Most existing recognition of a gripping posture of a user is currently applied to the single-screen terminal, and is generally performed by analyzing touch data of a screen. For instance, left and right hands when a user holds a terminal are recognized by computing trajectory slope according to a trajectory trend of a slide on a terminal screen by a user. Alternatively, left and right hands when a user holds a device are recognized by a deflection angle sensor in the device by using an inward inclination angle when the user holds the terminal. However, a user daily uses a terminal in plenty of cases, and this single determination standard will lead to a low accuracy rate of recognition, such that a gesture when the user holds the terminal is mistakenly determined. Moreover, the above method is mostly used for single-screen terminals, and is not suitable for foldable-screen terminals. Thus, the solution provides a method for recognizing gripping posture to solve these technical problems.

The disclosure relates to the field of terminal production, and particularly relates to a method and apparatus for recognizing gripping posture, an electronic device, a storage medium, and a chip.

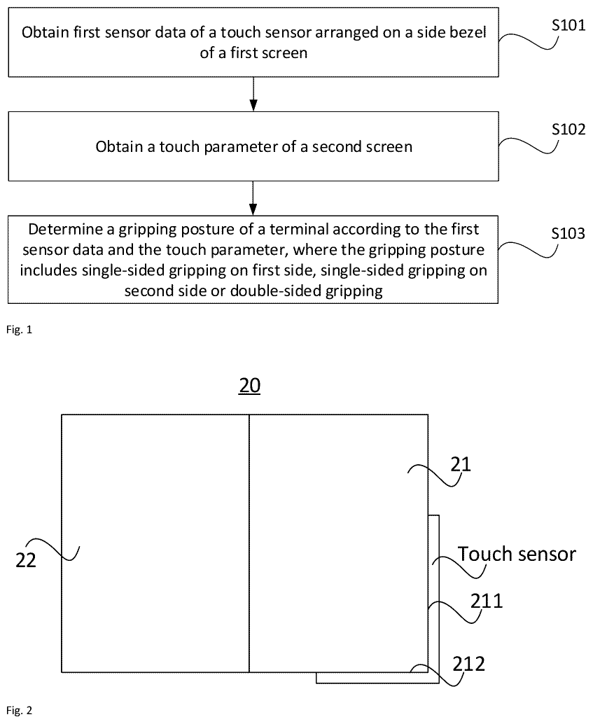

FIG. 1 is a flow diagram of a method for recognizing gripping posture according to an example. As shown in FIG. 1, this method is performed by a terminal. This terminal may be the above foldable-screen terminal and includes a foldable screen. This foldable screen includes a first screen and a second screen. The method includes the following steps S101-S103.

In step S101, obtain first sensor data of a touch sensor arranged on a side bezel of a first screen.

It can be understood that the foldable screen of this terminal includes a first screen and a second screen. One of the first screen and the second screen is a main screen and is arranged on a front of the terminal. The other one is a secondary screen and is located on a back of the terminal in a folded state. In the folded state, the main screen and the secondary screen may serve as two separate screens to display different contents respectively. In an unfolded state, the first screen and the second screen together constitute a combined screen having a larger size. The touch sensor is arranged on the side bezel of the first screen. This side bezel provided with the touch sensor is a side bezel of this first screen away from this second screen.

When a user holds the first screen, a corresponding hand touches the touch sensor arranged on the side bezel of the first screen. In this case, sensor data of the touch sensor changes, the touch sensor uploads first sensor data currently measured to (a processor of) the terminal, and the terminal may determine whether the first screen is held according to the first sensor data. This terminal may be a foldable-screen smart phone, or a foldable-screen tablet computer, etc.

In step S102, obtain a touch parameter of a second screen.

Correspondingly, when the user touches the second screen, this second screen will receive a touch signal. After detecting the touch signal, the second screen sends a corresponding touch parameter to (the processor of) the terminal, and the terminal determines whether the second screen is held based on this touch parameter.

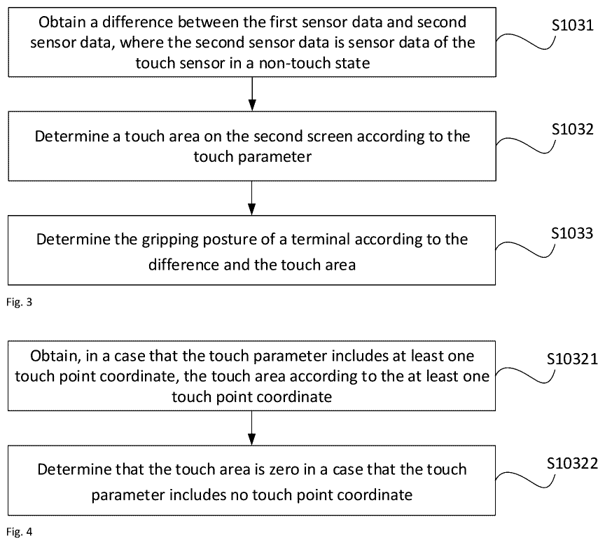

For example, FIG. 2 is a schematic structural diagram of a foldable-screen terminal in an unfolded state according to an example. As shown in FIG. 2, this foldable-screen terminal 20 includes a first screen 21 and a second screen 22, and a touch sensor is arranged on a side bezel of the first screen 21 away from the second screen 22.

In some examples, as shown in FIG. 2, this touch sensor may be distributed in an L shape and arranged on a side bezel 211 and a bottom frame 212 of the first screen 21, so as to cover a position on a right side of the terminal that is easy to hold.

Returning to FIG. 1, in step S103, determine a gripping posture of this terminal according to the sensor data and the touch parameter, where the gripping posture includes single-sided gripping on first side, single-sided gripping on second side or double-sided gripping.

The terminal device determines whether the first screen is held according to the sensor data and whether the second screen is held according to the touch parameter, so as to determine whether the gripping posture of the terminal is single-sided gripping on first side, single-sided gripping on second side or double-sided gripping according to whether the first screen and the second screen are held. The single-sided gripping on first side refers to one side of the first screen is held by one hand. The single-sided gripping on second side refers to one side of the second screen is held by one hand. The double-sided gripping refers to the first screen and the second screen are held by two hands at the same time. Based on a positional relation between the first screen 21 and the second screen 22 in FIG. 2, this first screen 21 is a screen located on a right side when the foldable screen is in an unfolded state, and this second screen 22 is a screen located on a left side when the foldable screen is in the unfolded state. Accordingly, this single-sided gripping on first side is right-handed single-sided gripping, and the single-sided gripping on second side is left-handed single-sided gripping.

It can be understood that when the foldable screen of this terminal is in a folded state, the second screen is located on a back of the terminal. In this state, when this terminal is held by a right hand, the right hand will touch this touch sensor and the second screen at the back. When this terminal is held by a left hand, the left hand will touch the second screen at the back, but a touched region is different from a touched region of the second screen during right-handed holding, and the touch sensor will not be touched. Based on this, sensor parameters and touch parameters collected when the terminal is held by the right hand and the left hand are different. Based on the above principle, the terminal device may also accurately recognize whether the gripping posture of a terminal in the folded state is the single-sided gripping on first side or the single-sided gripping on second side according to the sensor data and the touch parameter.

In some examples, a method for detecting whether this first screen is held and a method for detecting whether this second screen is held can be interchanged. That is, the touch sensor can also be arranged on the side bezel of the second screen. Thus, whether the second screen is held is determined by the touch sensor, and whether the first screen is held is determined by using the touch parameter. Alternatively, in another implementation, touch sensor may be arranged on the side bezel of the first screen and the side bezel of the second screen, such that whether these first screen and second screen are held is detected by the touch sensor. The detection method is the same as the above method, and will not be repeated.

In some examples, this touch sensor includes a specific absorption rate (SAR) sensor, and accordingly, this first sensor data is a specific absorption rate.

This touch parameter may include a touch point coordinate. This touch point coordinate may be configured to compute a touch area and determine whether the second screen is held based on this touch area.

In the above technical solution, the first sensor data of the touch sensor arranged on the side bezel of the first screen of the terminal foldable screen is obtained, the touch parameter of the second screen of this terminal foldable screen is obtained, and the gripping posture of the terminal is determined according to this sensor data and this touch parameter. This gripping posture includes the single-sided gripping on first side, the single-sided gripping on second side or the double-sided gripping. According to the above technical solution, the gripping posture of the terminal is determined by using the first sensor data of the first screen of the foldable screen and the touch parameter of the second screen such that the gripping posture of the foldable-screen terminal can be recognized, and an accuracy rate of recognizing the gripping posture of the terminal can be improved to a certain extent.

In some examples, FIG. 3 is a flow diagram of another method for recognizing gripping posture according to an example. As shown in FIG. 3, S103 may include steps S1031-S1033.

In step S1031, obtain a difference between the first sensor data and second sensor data, where the second sensor data is sensor data of the touch sensor in a non-touch state.

In step S1032, determine a touch area on the second screen according to the touch parameter.

It can be understood that if the user touches the second screen when holding the terminal, the second screen will generate a touch signal, such that this touch parameter is generated. Data included in this touch parameter may be configured to compute a touch area of the second screen touched by the user.

In step S1033, determine the gripping posture of a terminal according to the difference and the touch area.

In some examples, S1033 may further include: determine this gripping posture as the single-sided gripping on first side in cases that this difference is greater than a set difference threshold and this touch area is less than a set area threshold.

Determine this gripping posture as the single-sided gripping on second side in cases that this difference is less than a set difference threshold and this touch area is greater than a set area threshold.

Determine this gripping posture as the double-sided gripping in cases that this difference is greater than a set difference threshold and this touch area is greater than a set area threshold.

It can be understood that in cases that this difference is equal to the set difference threshold and this touch area is less than the set area threshold, this gripping posture can also be determined as the single-sided gripping on first side.

It is worth mentioning that in cases that this touch area is equal to the set area threshold, and this difference is less than the set difference threshold, this gripping posture can also be determined as the single-sided gripping on second side. Correspondingly, in cases that this difference is less than the set difference threshold and this touch area is less than the set area threshold, it can be determined that the gripping posture of this terminal is neither the single-sided gripping on first side, nor the single-sided gripping on second side, nor the double-sided gripping.

With the SAR sensor as an instance, after a first specific absorption rate sent by the SAR sensor is received, the first specific absorption rate is compared with a second specific absorption rate of the SAR sensor in a non-touch state, and a difference between the first specific absorption rate and the second specific absorption rate is obtained. If the difference between the first specific absorption rate and the second specific absorption rate is greater than a set specific absorption rate threshold, it can be determined that one side of the first screen where the SAR sensor is located is held. In a case that the touch area of the second screen is greater than the set area threshold, it can be determined that one side of the second screen is held. Thus, whether the gripping posture is the single-sided gripping on first side, the single-sided gripping on second side or the double-sided gripping, can be determined based on this difference and this touch area.

In some examples, FIG. 4 is a flow diagram of another method for recognizing gripping posture according to an example. As shown in FIG. 4, S1032 may include steps S10321-S10322.

In step S10321, obtain, in a case that the touch parameter includes at least one touch point coordinate, the touch area according to the at least one touch point coordinate.

In step S10322, determine that the touch area is zero in a case that the touch parameter includes no touch point coordinate.

It can be understood that when the user holds the second screen, the left hand of the user touches the second screen. In this case, this touch parameter is obtained. The touch parameter include a touch point coordinate collected by the second screen. There may be one or more touch point coordinates. The touch area between the hand of the user and the second screen can be obtained according to these touch point coordinates. In cases that the first screen and the second screen of this terminal are unfolded, and this touch area is greater than the area threshold, it can be determined that one side of the second screen of the terminal is held.

In some examples, FIG. 5 is a schematic diagram of a display interface of a terminal according to an example. As shown in FIG. 5, in the terminal 40, in a case that this gripping posture is single-sided gripping on first side, display interfaces of the first screen 401 and the second screen 402 are adjusted to display interfaces 403 of a single-handed mode corresponding to the single-sided gripping on first side. In a case that this gripping posture is the single-sided gripping on second side, the display interfaces of the first screen 401 and the second screen 402 are adjusted to display interfaces 404 of a single-handed mode corresponding to the single-sided gripping on second side. In a case that this gripping posture is the double-sided gripping, the display interfaces of the first screen 401 and the second screen 402 are adjusted to display interfaces 405 of a double-handed mode.

In some examples, this first screen is a screen located on a right side when this foldable screen is unfolded, this second screen is a screen located on a left side when this foldable screen is unfolded, this single-sided gripping on first side is right-handed gripping, and this single-sided gripping on second side is left-handed gripping; or

this first screen is a screen located on a left side when this foldable screen is unfolded, this second screen is a screen located on a right side when this foldable screen is unfolded, this single-sided gripping on first side is left-handed gripping, and this single-sided gripping on second side is right-handed gripping.

It can be understood that a position of the SAR sensor can be adjusted. In a case that this first screen is a screen located on a right side when the foldable screen is unfolded, the SAR sensor is arranged on the side bezel of the screen on the right side of the terminal, and accordingly single-sided gripping on first side is right-handed single-handed holding of a user. In a case that this second screen is a screen on a left side when the foldable screen is unfolded, the second screen is configured to measure a touch parameter after the left hand of the user touches the second screen on the left side, such that a touch area between the left hand of the user and the second screen is obtained. Moreover, single-sided gripping on second side is left-handed single-handed holding of a user.

Alternatively, in a case that the first screen is a screen located on a left side when the foldable screen is in an unfolded state, the SAR sensor is arranged on a side bezel of a screen on the left side of the terminal, and accordingly single-sided gripping on first side is left-handed single-handed holding of a user. In a case that this second screen is a screen located on a right side when the foldable screen is unfolded, the second screen is configured to measure a touch parameter after the right hand of the user touches the second screen on the right side, such that a touch area between the right hand of the user and the second screen is obtained. Moreover, single-sided gripping on second side is right-handed single-handed holding of a user.

According to the above technical solution, whether the gripping posture of the terminal is the gripping on first side, the gripping on second side or the double-sided gripping, is determined according to the difference between the first sensor data and the second sensor data of the touch sensor and through comparison between the touch area of the screen and the area threshold. And arrangement positions of the touch sensor and the secondary screen are described. Moreover, display interfaces of the terminal can also correspondingly change in cases of different terminal holding postures. Application flexibility is improved while the gripping posture of the terminal is determined, and the display interfaces are correspondingly changed after the gripping posture of the terminal is determined, such that user experience is improved to a certain extent.

An illustrative application scene of the method for recognizing gripping posture provided by the disclosure is described below. A user may hold a foldable screen device in different gripping postures. For example, the foldable screen device may include but is not limited to electronic devices with foldable screens such as a foldable-screen smart phone, or a foldable-screen tablet computer, etc. The gripping postures may include single-sided gripping on first side, where the user holds the first screen of the foldable screen device with one hand, single-sided gripping on second side, where the user holds the second screen of the foldable screen device with one hand, and double-sided gripping, where the user holds both the first screen and the second screen of the foldable screen device with both hands. The foldable screen device may determine the user's gripping posture of the foldable screen device according to the above steps S101 to S103. After determining the gripping posture, the foldable screen device may also adjust the interface display of the first screen and/or the second screen. So that the foldable screen device is enabled to adaptively adjusts the interface display of the first screen and the second screen to meet the user's usage intentions.

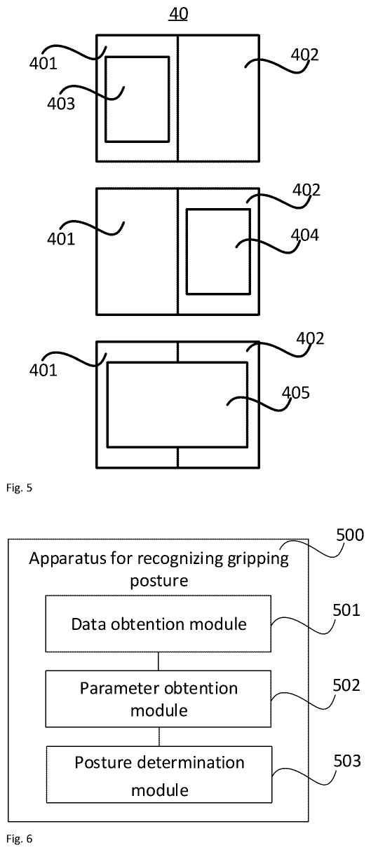

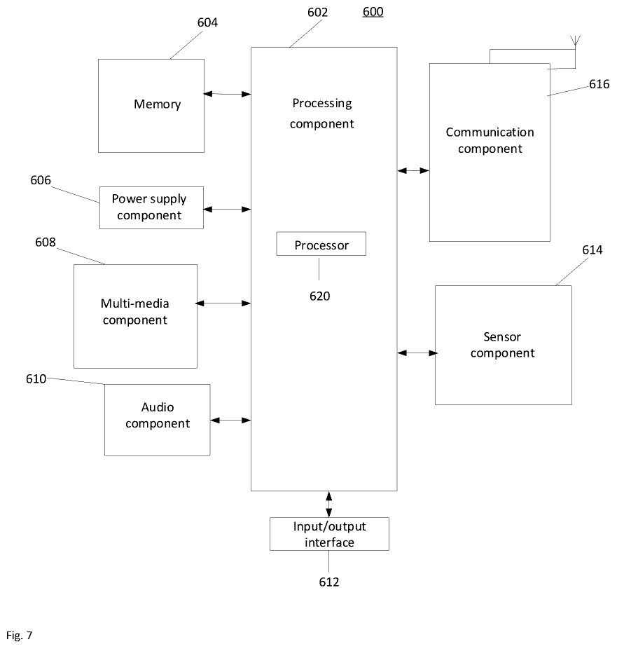

FIG. 6 is a block diagram of an apparatus for recognizing gripping posture according to an example. This apparatus is used in a terminal. This terminal includes a foldable screen. This foldable screen includes a first screen and a second screen. As shown in FIG. 6, this apparatus 500 for recognizing gripping posture may include: a data obtention module 501, a parameter obtention module 502 and a posture determination module 503.

The data obtention module 501, which is configured to obtain first sensor data of a touch sensor arranged on a side bezel of this first screen.

The parameter obtention module 502, which is configured to obtain a touch parameter of this second screen.

The posture determination module 503, which is configured to determine a gripping posture of this terminal according to this first sensor data and this touch parameter, where this gripping posture includes single-sided gripping on first side, single-sided gripping on second side or double-sided gripping.

In the above technical solution, the first sensor data of the touch sensor arranged on the side bezel of the first screen of the terminal foldable screen is obtained, the touch parameter of the second screen of this terminal foldable screen is obtained, and the gripping posture of the terminal is determined according to this sensor data and this touch parameter. This gripping posture includes the single-sided gripping on first side, the single-sided gripping on second side or the double-sided gripping. According to the above technical solution, the gripping posture of the terminal is determined by using the first sensor data of the first screen of the foldable screen and the touch parameter of the second screen such that the gripping posture of the foldable-screen terminal can be recognized, and an accuracy rate of recognizing the gripping posture of the terminal can be improved to a certain extent.

In some examples, this gesture determination module 503 is configured to:
obtain a difference between this first sensor data and second sensor data, where this second sensor data is sensor data of this touch sensor in a non-touch state;
determine a touch area on this second screen according to this touch parameter; and
determine the gripping posture of this terminal according to this difference and this touch area.

In some examples, this gesture determination module 503 is configured to:
determine this gripping posture as the single-sided gripping on first side in cases that this difference is greater than a set difference threshold and this touch area is less than a set area threshold.

In some examples, this gesture determination module 503 is configured to:
determine this gripping posture as the single-sided gripping on second side in cases that this difference is less than a set difference threshold and this touch area is greater than a set area threshold.

In some examples, this gesture determination module 503 is configured to:
determine this gripping posture as the double-sided gripping in cases that this difference is greater than a set difference threshold and this touch area is greater than a set area threshold.

In some examples, this gesture determination module 503 is configured to:
obtain, in a case that this touch parameter includes at least one touch point coordinate, this touch area according to this at least one touch point coordinate; and

determine that this touch area is zero in a case that this touch parameter includes no touch point coordinate.

In some examples, this apparatus 500 for recognizing gripping posture may further include an interface control module, which is configured to:
adjust, in a case that this gripping posture is the single-sided gripping on first side, display interfaces of this first screen and this second screen to display interfaces of a single-handed mode corresponding to the single-sided gripping on first side;
adjust, in a case that this gripping posture is the single-sided gripping on second side, the display interfaces of this first screen and this second screen to display interfaces of a single-handed mode corresponding to the single-sided gripping on second side; and
adjust, in a case that this gripping posture is the double-sided gripping, the display interfaces of this first screen and this second screen to display interfaces of a double-handed mode.

In some examples, this first screen is a screen located on a right side when this foldable screen is unfolded, this second screen is a screen located on a left side when this foldable screen is unfolded, this single-sided gripping on first side is right-handed holding, and this single-sided gripping on second side is left-handed holding; or
this first screen is a screen located on a left side when this foldable screen is unfolded, this second screen is a screen located on a right side when this foldable screen is unfolded, this single-sided gripping on first side is left-handed holding, and this single-sided gripping on second side is right-handed holding.

According to the above technical solution, the terminal can determine whether the gripping posture of the terminal is the first-side holding, the second-side holding or the double-sided gripping according to a difference between the first sensor data and the second sensor data of the touch sensor and through comparison between the touch area of the screen and the area threshold. Moreover, in cases of different terminal holding postures, the display interface of the terminal can be adaptively adjusted such that flexibility of interface display can be improved based on the terminal gripping posture, and user experience can be improved.

A method for each module of the apparatus in the above examples to execute an operation is described in detail in examples related to this method, and will not be described in detail here.

The disclosure further provides a computer-readable storage medium. The computer-readable storage medium stores a computer program instruction. This program instruction implements steps of the method for recognizing gripping posture provided in the disclosure when executed by a processor.

It is worth mentioning that this terminal may also be a non-foldable-screen electronic device having a large-size screen, such as a non-foldable-screen tablet computer. A screen of this non-foldable-screen tablet computer may be divided into a first screen region and a second screen region as a first screen and a second screen respectively such that the above method can be executed.

FIG. 7 is a block diagram of an apparatus 600 for recognizing gripping posture according to an example. For instance, the apparatus 600 may be a mobile phone, a computer, a digital broadcasting terminal, a message receiving and transmitting device, a game console, a portable android device, a medical device, a fitness device, a personal digital assistant, and other electronic devices.

With reference to FIG. 7, the apparatus 600 may include one or more of components as follows: a processing component 602, a memory 604, a power supply component 606, a multi-media component 608, an audio component 610, an input/output interface 612, a sensor component 614 and a communication component 616.

The processing component 602 generally controls overall operations of the apparatus 600, such as operations associated with display, telephone call, data communication, camera operations and record operations. The processing component 602 may include one or more processors 620 to execute an instruction, so as to complete all or some steps of the above method. In addition, the processing component 602 may include one or more modules such that the processing component 602 and other components can interact with each other. For instance, the processing component 602 may include a multi-media module such that the multi-media component 608 and the processing component 602 can interact with each other.

The memory 604 is configured to store various types of data to support operations at the apparatus 600. Instances of such data include instructions configured for any application or method operating on the apparatus 600, such as contact data, phonebook data, messages, pictures and video. The memory 604 may be implemented by any type of volatile or non-volatile storage devices or their combinations, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply component 606 provides power for various components of the apparatus 600. The power supply component 606 may include a power supply management system, one or more power supplies, and other components associated with generation, management and power distribution of the apparatus 600.

The multi-media component 608 includes a screen that provides an output interface between the apparatus 600 and a user. In some examples, the screen may include a liquid crystal display (LCD) and a touch panel (TP). If the screen includes a touch panel, the screen can be implemented as a touch screen to receive an input signal from a user. The touch panel includes one or more touch sensors to sense a touch, a swipe and a gesture on the touch panel. The touch sensor can not only sense a boundary of a touch or a swipe, but also measure duration and force associated with the touch or the swipe. In some examples, the multi-media component 608 includes a front-facing camera and/or a rear-facing camera. When the apparatus 600 is in an operating mode, such as a photographing mode or a video mode, the front-facing camera and/or the rear-facing camera can receive external multi-media data. Each of the front-facing camera and the rear-facing camera may be a fixed optical lens system or have focusing and optical zooming capabilities.

The audio component 610 is configured to output and/or input an audio signal. For instance, the audio component 610 includes a microphone (MIC). When the apparatus 600 is in an operating mode, such as a call mode, a recording mode or a voice recognition mode, the microphone is configured to receive an external audio signal. The received audio signal may be further stored in the memory 604 or transmitted by means of the communication component 616. In some examples, the audio component 610 further includes a loudspeaker configured to output an audio signal.

The input/output interface 612 provides an interface between the processing component 602 and peripheral interface modules, which may be keyboards, click wheels, buttons, etc. These buttons may include but are not limited to a home button, a volume button, a start button and a lock button.

The sensor component 614 includes one or more sensors, which are configured to provide state assessment of various aspects for the apparatus 600. For instance, the sensor component 614 may detect a startup/shutdown state of the apparatus 600, and relative positioning of components, which are a display and a keypad of the apparatus 600 for instance. The sensor component 614 may further detect a position change of the apparatus 600 or an component of the apparatus 600, presence or absence of a touch between a user and the apparatus 600, an orientation or acceleration/deceleration of the apparatus 600, and a temperature change of the apparatus 600. The sensor component 614 may include a proximity sensor, which is configured to detect the presence of a nearby object in the absence of any physical touch. The sensor component 614 may further include a light sensor, such as a complementary metal oxide semiconductor (CMOS) or charge coupled device (CCD) image sensor, which are configured to be used in imaging applications. In some examples, this sensor component 614 may further include an acceleration sensor, a gyroscopic sensor, a magnetic sensor, a pressure sensor or a temperature sensor.

The communication component 616 is configured to facilitate wired or wireless communication between the apparatus 600 and other devices. The apparatus 600 may access a wireless network based on a communication standard, such as Wi-Fi, 2G, 3G, or their combinations. In an example, the communication component 616 receives a broadcast signal or broadcast related information from an external broadcast management system by means of a broadcast channel. In an example, the communication component 616 further includes a near-field communication (NFC) module to promote short-range communication. For instance, the NFC module may be implemented based on a radio frequency identification (RFID) technology, an infrared data association (IrDA) technology, an ultra wideband (UWB) technology, a Bluetooth (BT) technology and other technologies.

In an example, the apparatus 600 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors or other electronic elements, and is configured to execute the above method for recognizing gripping posture.

In an example, a non-transitory computer-readable storage medium including an instruction is further provided, such as a memory 604 including an instruction. The above instruction may be executed by the processor 620 of the apparatus 600 to complete the above method for recognizing gripping posture. For instance, the non-transitory computer-readable storage medium may be an ROM, a random access memory (RAM), a compact disc read-only memory (CD-ROM), a magnetic tape, a floppy disk or an optical data storage device, etc.

The above apparatus may be an independent electronic device, or may be a part of an independent electronic device. For instance, in an example, this apparatus may be an integrated circuit (IC) or a chip, and this integrated circuit may be one IC or a set of a plurality of ICs. This chip may include but is not limit to types as follows: a graphics processing unit (GPU), a central processing unit (CPU), a field programmable gate array (FPGA), a digital signal processor (DSP), an application specific integrated circuit (ASIC), a system on chip (SOC), etc. The above integrated circuit or chip may be configured to execute an executable instruction (or code) to implement the above method for recognizing gripping posture. This executable instruction may be stored in this integrated circuit or chip, or retrieved from other apparatuses or devices. For instance, this integrated circuit or chip includes a processor, a memory, and interfaces for communication with other apparatuses. This executable instruction may be stored in this memory, and implement the above method for recognizing gripping posture when executed by the processor. Alternatively, this integrated circuit or the chip may receive the executable instruction through this interface and transmit the executable instruction to this processor for execution, so as to implement the above method for recognizing gripping posture.

In another example, a computer program product is provided. This computer program product includes a computer program capable of being executed by a programmable apparatus. This computer program has a code portion, which is configured to execute the above method for recognizing gripping posture when executed by the programmable apparatus.

In some examples, the determining the gripping posture of the terminal according to the first sensor data and the touch parameter includes:
obtaining a difference between the first sensor data and second sensor data, where the second sensor data is sensor data of the touch sensor in a non-touch state;
determining a touch area on the second screen according to the touch parameter; and
determining the gripping posture of the terminal according to the difference and the touch area.

In some examples, the determining the gripping posture of the terminal according to the difference and the touch area includes:
determining the gripping posture as the single-sided gripping on first side in cases that the difference is greater than a set difference threshold and the touch area is less than a set area threshold.

In some examples, the determining the gripping posture of the terminal according to the difference and the touch area includes:
determining the gripping posture as the single-sided gripping on second side in cases that the difference is less than a set difference threshold and the touch area is greater than a set area threshold.

In some examples, the determining the gripping posture of the terminal according to the difference and the touch area includes:
determining the gripping posture as the double-sided gripping in cases that the difference is greater than a set difference threshold and the touch area is greater than a set area threshold.

In some examples, the determining the touch area on the second screen according to the touch parameter includes:
obtaining, in a case that the touch parameter includes at least one touch point coordinate, the touch area according to the at least one touch point coordinate; and
determining that the touch area is zero in a case that the touch parameter includes no touch point coordinate.

In some examples, the method further includes:
adjusting, in a case that the gripping posture is the single-sided gripping on first side, display interfaces of the first screen and the second screen to display interface of a single-handed mode corresponding to the single-sided gripping on first side;
adjusting, in a case that the gripping posture is the single-sided gripping on second side, the display interfaces of the first screen and the second screen to display interface of a single-handed mode corresponding to the single-sided gripping on second side; and
adjusting, in a case that the gripping posture is the double-sided gripping, the display interfaces of the first screen and the second screen to display interfaces of a double-handed mode.

In some examples, the first screen is a screen located on a right side when the foldable screen is unfolded, the second screen is a screen located on a left side when the foldable screen is unfolded, the single-sided gripping on first side is right-handed gripping, and the single-sided gripping on second side is left-handed gripping; or
the first screen is a screen located on a left side when the foldable screen is unfolded, the second screen is a screen located on a right side when the foldable screen is unfolded, the single-sided gripping on first side is left-handed gripping, and the single-sided gripping on second side is right-handed gripping.

In some examples, the touch sensor includes a specific absorption rate (SAR) sensor, and the first sensor data is a specific absorption rate.

Technical solutions provided in examples of the disclosure may include beneficial effects as follows:
in the above technical solution, the first sensor data of the touch sensor arranged on the side bezel of the first screen of the terminal foldable screen is obtained, the touch parameter of the second screen of the terminal foldable screen is obtained, and the gripping posture of the terminal is determined according to the sensor data and the touch parameter. The gripping posture includes the single-sided gripping on first side, the single-sided gripping on second side or the double-sided gripping. According to the above technical solution, the gripping posture of the terminal is determined by using the first sensor data of the first screen of the foldable screen and the touch parameter of the second screen such that the gripping posture of the foldable-screen terminal can be recognized, and an accuracy rate of recognizing the gripping posture of the terminal can be improved to a certain extent.

A person skilled in the art could easily conceive of other implementation solutions of the disclosure upon consideration of the description and the disclosure disclosed in the implementation. The disclosure is intended to cover any variations, uses or adaptive changes of the disclosure, which follow the general principles of the disclosure and include common general knowledge or customary technical means in the art that is not disclosed in the disclosure. The description and examples are regarded as illustrative merely. The true scope and spirit of the disclosure are indicated by the following claims.

It should be understood that the disclosure is not limited to a precise structure described above and shown in accompanying drawings, and can have various modifications and changes without departing from the scope of the disclosure. The scope of the disclosure is limited by the appended claims merely.

1. A method for recognizing gripping posture, performed by a terminal, wherein the terminal comprises a foldable screen, the foldable screen comprises a first screen and a second screen, and the method comprises:
obtaining first sensor data of a touch sensor arranged on a side bezel of the first screen;
obtaining a touch parameter of the second screen; and
determining the gripping posture of the terminal according to the first sensor data and the touch parameter, wherein the gripping posture comprises single-sided gripping on first side, single-sided gripping on second side or double-sided gripping.

2. The method according to claim 1, wherein the determining the gripping posture of the terminal according to the first sensor data and the touch parameter comprises:
obtaining a difference between the first sensor data and second sensor data, wherein the second sensor data is sensor data of the touch sensor in a non-touch state;
determining a touch area on the second screen according to the touch parameter; and
determining the gripping posture of the terminal according to the difference and the touch area.

3. The method according to claim 2, wherein the determining the gripping posture of the terminal according to the difference and the touch area comprises:
determining the gripping posture as the single-sided gripping on first side in cases that the difference is greater than a set difference threshold and the touch area is less than a set area threshold.

4. The method according to claim 2, wherein the determining the gripping posture of the terminal according to the difference and the touch area comprises:
determining the gripping posture as the single-sided gripping on second side in cases that the difference is less than a set difference threshold and the touch area is greater than a set area threshold.

5. The method according to claim 2, wherein the determining the gripping posture of the terminal according to the difference and the touch area comprises:
determining the gripping posture as the double-sided gripping in cases that the difference is greater than a set difference threshold and the touch area is greater than a set area threshold.

6. The method according to claim 2, wherein the determining the touch area on the second screen according to the touch parameter comprises:
obtaining, in a case that the touch parameter comprises at least one touch point coordinate, the touch area according to the at least one touch point coordinate.

7. The method according to claim 1, wherein the method further comprises:
adjusting, in a case that the gripping posture is the single-sided gripping on first side, display interfaces of the first screen and the second screen to display interface of a single-handed mode corresponding to the single-sided gripping on first side.

8. The method according to claim 1, wherein
the first screen is a screen located on a right side when the foldable screen is unfolded, the second screen is a screen located on a left side when the foldable screen is unfolded, the single-sided gripping on first side is right-handed gripping, and the single-sided gripping on second side is left-handed gripping.

9. The method according to claim 1, wherein the touch sensor comprises a specific absorption rate (SAR) sensor, and the first sensor data is a specific absorption rate.

10. (canceled)

11. An electronic device, applied to a terminal, wherein the terminal comprises a foldable screen, the foldable screen comprises a first screen and a second screen, and the electronic device comprises:
a processor; and
a memory configured to store a processor-executable instruction; wherein the processor is configured to:
obtain first sensor data of a touch sensor arranged on a side bezel of the first screen;
obtain a touch parameter of the second screen; and
determine a gripping posture of the terminal according to the first sensor data and the touch parameter, wherein the gripping posture comprises single-sided gripping on first side, single-sided gripping on second side or double-sided gripping.

12. A non-transitory_computer-readable storage medium, storing a computer program instruction, applied to a terminal, wherein the terminal comprises a foldable screen, the foldable screen comprises a first screen and a second screen, and the computer program instruction, when executed by a processor, implements following steps of:
obtaining first sensor data of a touch sensor arranged on a side bezel of the first screen;
obtaining a touch parameter of the second screen; and
determining a gripping posture of the terminal according to the first sensor data and the touch parameter, wherein the gripping posture comprises single-sided gripping on first side, single-sided gripping on second side or double-sided gripping.

13. (canceled)

14. The method according to claim 2, wherein the determining the touch area on the second screen according to the touch parameter comprises:
determining that the touch area is zero in a case that the touch parameter comprises no touch point coordinate.

15. The method according to claim 1, wherein the method further comprises:
adjusting, in a case that the gripping posture is the single-sided gripping on second side, display interfaces of the first screen and the second screen to display interface of a single-handed mode corresponding to the single-sided gripping on second side.

16. The method according to claim 1, wherein the method further comprises:
adjusting, in a case that the gripping posture is the double-sided gripping, display interfaces of the first screen and the second screen to display interface of a double-handed mode.

17. The method according to claim 1, wherein the first screen is a screen located on a left side when the foldable screen is unfolded, the second screen is a screen located on a right side when the foldable screen is unfolded, the single-sided gripping on first side is left-handed gripping, and the single-sided gripping on second side is right-handed gripping.

18. The electronic device according to claim 11, wherein the processor is further configured to:
obtain a difference between the first sensor data and second sensor data, wherein the second sensor data is sensor data of the touch sensor in a non-touch state;
determine a touch area on the second screen according to the touch parameter; and
determine the gripping posture of the terminal according to the difference and the touch area.

19. The electronic device according to claim 11, wherein the processor is further configured to:
adjust, in a case that the gripping posture is the single-sided gripping on first side, display interfaces of the first screen and the second screen to display interface of a single-handed mode corresponding to the single-sided gripping on first side.

20. The electronic device according to claim 11, wherein the processor is further configured to:
adjust, in a case that the gripping posture is the single-sided gripping on second side, display interfaces of the first screen and the second screen to display interface of a single-handed mode corresponding to the single-sided gripping on second side.

21. The electronic device according to claim 11, wherein the processor is further configured to:
adjust, in a case that the gripping posture is the double-sided gripping, display interfaces of the first screen and the second screen to display interface of a double-handed mode.

22. The electronic device according to claim 18, wherein the processor is further configured to:
determine the gripping posture as the single-sided gripping on first side in cases that the difference is greater than a set difference threshold and the touch area is less than a set area threshold.
